(19) United States
(12) Patent Application Publication
(10) Pub. No.: US 2011/0293774 A1
(43) Pub. Date: Dec. 1, 2011

(54) GATE ADAPTER AND GATE SYSTEM FOR A GATE ADAPTER

(75) Inventor: Joachim Scheffer, Sundern (DE)

(73) Assignee: MHT MOLD & HOTRUNNER TECHNOLOGY AG, Hochheim (DE)

(21) Appl. No.: 12/739,895

(22) PCT Filed: Oct. 23, 2008
(86) PCT No.: PCT/EP2008/064398

§ 371 Date: Aug. 9, 2011

(30) Foreign Application Priority Data
Nov. 3, 2007 (DE) 10 2007 052 597.6

(51) Int. Cl. B29C 45/74

(52) U.S. Cl. 425/549

(57) ABSTRACT

A gate adapter for receiving a molten molding material and for the discharge thereof to a gate distributor block (9), wherein the gate adapter (7) has an inlet (10) for receiving the molten molding material, first and second outlets for the controlled discharge of the molten molding material and first and second closable connecting passages (18, 18′) which respectively connect an outlet to the inlet (10) and a gate distributor block for connection to a gate adapter as set forth in claim 20 wherein at least the gate distributor block (9) has two inlets for connection to outlets of the gate adapter (7) and at least two ingate passages (13) for connection to a mold cavity, wherein each ingate passage (13) is connected by way of distributor passages to at least one inlet of the gate distributor block (9).

### BACKGROUND OF THE INVENTION

The present invention concerns a gate adapter, a gate distributor block for connection to a gate adapter and a system comprising a gate adapter and a gate distributor block.

In the plastic injection molding technology a plastic material is plasticised and the molten material is introduced into a shaping cavity and there cooled down under pressure. The hardened molding is then ejected from the tool.

Plasticisation of the plastic material is generally effected by means of a screw which discharges the molten molding material by way of a nozzle. Particularly in the production of large moldings, for example fenders for the automobile industry, the tool cavity is filled with the molten molding material by way of a multiplicity of inlets.

As however the plasticising screw discharges the plasticised plastic material only by way of one nozzle, in general there is provided a distributor system which transports the molten molding material to the individual inlets to the tool cavity.

The distributor system is also referred to as a gate or sprue system. The gate system has a receiving means for the molten molding material and a series of ingate passages which connect the gate system to the tool cavity or the injection molding.

The gate system influences the injection operation and is thus crucial for the quality of the molding to be produced.

Therefore, in terms of the dimensioning of the gate system, it is necessary to take account not only of the molding material to be processed but also the external shape of the molding.

Gate systems are frequently heated and are then alternatively also referred to as a hot runner or hot runner system.

Particularly in the injection molding of large moldings by way of a whole series of ingate passages, under some circumstances flow seams can occur if a plurality of flow fronts meet each other during the filling operation in the tool. Such flow seams worsen the surface quality and the strength properties of the finished molding.

To avoid flow seams it is already usual to provide for sequential injection. In the case of sequential injection molding, also referred to as cascade injection molding, the cavity is firstly filled only by way of one ingate passage during the filling operation. As soon as the flow front of the molten material overflows a further ingate passage, that is also opened so that further molten material is injected directly into the flow of molten material which is already present, by way of the additional ingate. That measure makes it possible to produce large moldings with a thin wall gauge as the plurality of ingate passages means that the filling pressure can be well distributed over the entire cavity without flow fronts which have already cooled down encountering each other during the filling operation and forming unwanted flow seams.

Cascade injection molding however suffers from the disadvantage that each ingate passage must have its own independently controllable closure nozzle so that the respective ingate passages can be opened and closed independently of each other.

By way of example FIGS. 1 and 2 show a typical hot runner as a perspective view (FIG. 1) and a sectional view (FIG. 2). The hot runner 1 has an inlet 2 for receiving the molten material. The inlet, the so-called gate or sprue bush 2, is connected to a distributor passage 3 which extends substantially perpendicularly to the gate bush 2 and from which in turn a whole row of connecting passages 4 arranged in mutually parallel relationship extend perpendicularly. The end of the connecting passages 4, that is remote from the gate bush 2, is the so-called ingate passage. It is here that there is the connecting location between the hot runner 1 on the one hand and the tool cavity (not shown) on the other hand. The connecting passages 4 extending in mutually parallel relationship are each individually actuable by way of needle valves 5.

The known hot runners are however very complicated and expensive to produce. In addition the needle valves 5 take up a very great deal of space, which increases the dimensions of the injection molding machine.

It can happen that other moldings are to be produced using the same injection molding machine. For that purpose it is necessary to replace the actual injection molding tool which contains the tool cavity. In addition however the hot runner also has to be replaced as generally, when dealing with a molding of different dimensions, the ingate passages are also positioned differently. To replace the hot runner it is therefore necessary to release the actuating connections (electrical and/or hydraulic) of the individual closure valves and to disconnect the entire hot runner at the gate bush.

The old hot runner cannot be readily put to further use. Instead it is now necessary to produce a fresh hot runner which again has a plurality of closure valves for actuation of the ingate passages, and connect it to the gate bush. In addition each closure valve has to be connected to its corresponding actuating system.

### BRIEF SUMMARY OF THE INVENTION

Taking that state of the art as its starting point therefore the object of the present invention is to provide a gate distributor block which can be replaced more easily and thus more quickly and in addition can be produced with less material.

According to the invention that object is attained by a gate distributor block with a gate adapter.

The gate adapter is for receiving a molten molding material and for the discharge thereof to a gate distributor block, wherein the gate adapter has an inlet for receiving the molten molding material, first and second outlets for the controlled discharge of the molten molding material and first and second closable connecting passages which respectively connect an outlet to the inlet.

The gate distributor block is for connection to a gate adapter as set forth in claim 20 wherein at least the gate distributor block has two inlets for connection to outlets of the gate adapter and at least two ingate passages for connection to a mold cavity, wherein each ingate passage is connected by way of distributor passages to at least one inlet of the gate distributor block.

### BRIEF DESCRIPTION OF THE SEVERAL VIEWS OF THE DRAWINGS

FIG. 1 shows a perspective view of a hot runner in the state of the article,

FIG. 2 shows a sectional view of the hot runner in the state of the art in FIG. 1,

FIG. 3 shows a perspective view of a particularly preferred embodiment of the gate system according to the invention,

FIG. 4 shows a sectional view through the gate adapter of the embodiment of FIG. 3,

FIG. 5 shows a sectional view through the gate distributor block of the embodiment of FIG. 3, and

FIG. 6 shows a sectional view of the gate system of FIG. 3 in the condition of being fitted into the injection molding machine.

### DETAILED DESCRIPTION OF THE INVENTION

The gate adapter serves to receive a molten molding material and to discharge it to a gate distributor block. In accordance with the invention the gate adapter has an inlet for receiving the molten molding material, first and second outlets for the controlled delivery of the molten molding material, and first and second closable connecting passages which respectively connect an outlet to the inlet. Accordingly the gate distributor block has two inlets for connection to the outlets of the gate adapter and at least two ingate passages for connection to a mold cavity, wherein each ingate passage is connected by way of distributor passages to at least one inlet of gate distributor block.

In other words the gate distributor system according to the invention comprises a gate adapter which includes the closure elements and a gate distributor block which has substantially only distributor passages which provide that the liquid molten material is delivered from the inlet to the appropriately arranged ingate passage.

In the situation where a different molding is to be produced it is then only necessary to replace the gate distributor block, but not the gate adapter. In the production of a new gate distributor block it is then only necessary to ensure that the inlets of the gate distributor block are so arranged that they can be connected to the outlets of the gate adapter.

The measure according to the invention provides that the closure elements can be put to further use, even if the shape of the molding to be produced changes and if therefore the position of the ingate passages has to be changed.

In principle it is therefore possible for the gate adapter which has only one inlet for receiving the molten molding material generally directly from the extruder screw to divide up that flow of molten material into a plurality of flows of molten material, even if a smaller number of flows of molten material is used. The gate adapter can thus be universally employed.

The gate distributor block then has a series of inlets, the number of which does not necessarily have to coincide with the number of outlets of the gate adapter. Depending on the respective situation of use it may be advantageous if the gate distributor block uses only some of the outlets of the gate adapter and simply seals off the further outlets. In principle it is also possible for the outlets which are not required to be simply left open and for them to be closed with the corresponding closure elements of the gate adapter. In addition it is equally possible for the gate distributor block to be of such a structure that it connects two inlets and thus two outlets of the gate adapter to one and the same ingate passage. That measure means that a larger amount of molding material can be transported to the ingate passage in question.

In addition it may be advantageous for many situations of use if the closure elements can also partially (or steplessly) open or close so that the amount of molten material and/or the pressure of molten material can be influenced by way of the closure elements. In principle that measure also permits specific targeted regulation of the flow of the molten material.

In contrast to the gate systems of the state of the art which both divide up and also distribute the molten material, it is thus proposed in accordance with the invention that the individual functions of the gate distributor system are separated so that the gate adapter is responsible for dividing up a molten material into a plurality of molten materials which can be respectively controlled by means of a closure element, while the gate distributor block is only responsible for distributing the molten material, that is to say feeding the flows of molten material to the individual ingate points. The gate adapter is therefore a branching element with control in respect of the through flow through the individual branches while the gate distributor block is a distributor element.

In a preferred embodiment it is provided that the connecting passages of the gate adapter are closable separately from each other without adversely affecting the flow through other connecting passages thereby. In other words the connecting passages are connected in parallel relationship so that the closure of a connecting passage only provides that no more molten material is discharged at the outlet in question.

In principle it may also be advantageous for many situations of use if connecting passages are connected in series, with the result that the closure of a connecting passage at the same time closes a plurality of outlets. That can be appropriate in particular in the case of the above-mentioned cascade injection molding procedure as here individual ingate passages are frequently always opened in addition to ingate passages which are already opened. In other words a first connecting passage connects an inlet of the gate adapter to an outlet and a second connecting passage connects the first outlet to a second outlet. As both connecting passages are closable both outlets can be closed by the closure element associated with the first connecting passage. If the closure element associated with the first connecting passage is opened, the closure element associated with the second connecting passage determines whether only the first outlet or both outlets are opened.

Preferably closure valves, particularly preferably needle valves, are used as closure elements.

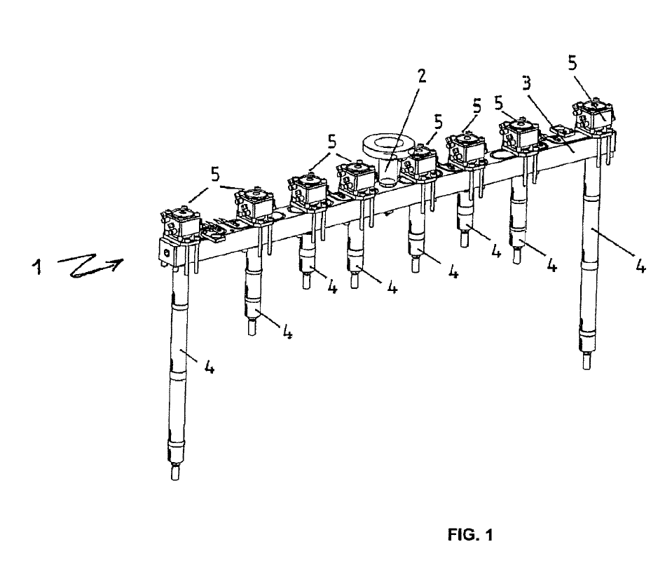

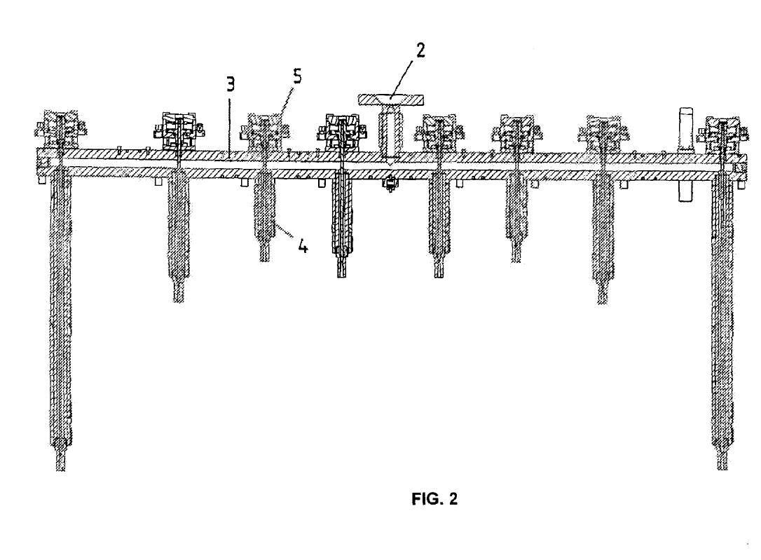

Even if the invention is described hereinafter by reference to a gate adapter having two outlets and by reference to a gate distributor block having two ingate passages, it will however be appreciated that obviously more than two outlets can be provided. To replace the hot runner of the state of the art, as shown in FIGS. 1 and 2, by the gate system according to the invention, the gate adapter would have to have at least eight outlets.

In a preferred embodiment the gate adapter is of a substantially plate-shaped configuration with a first side surface, a second side surface and a peripherally extending edge surface connecting the first side surface to the second side surface. In that case the inlet is preferably arranged at the first side surface and the outlets at the second side surface. It is for example also possible for at least some closure elements to be arranged at the peripherally extending edge surfaces.

In a particularly preferred embodiment at least two and preferably all outlets of the gate adapter are arranged in a continuous connecting region, the surface area of which is preferably less than 200 cm², particularly preferably less than 150 cm² and at best less than 100 cm². The outlets are arranged on a surface which is as small as possible so that the gate distributor block to be connected can also arrange its outlets on a surface area which is as small as possible, thereby saving on material and thus heating power. In that case the gate distributor block advantageously has a continuous connecting region of approximately equal size, in which at least two and preferably all inlets are arranged.

If there are provided a plurality of gate adapters it is also possible to use melts of different materials together in one injection molding operation (for example co-injection).

For many situations of use it may be advantageous if the gate adapter additionally has an extension sleeve with at least two passages which extend substantially parallel and which connect the one end to the other end of the extension sleeve. The extension sleeve preferably has precisely as many passages extending in parallel relationship, as the gate adapter has outlets. The extension sleeve can then be connected to the outlets of the gate adapter, in which case the oppositely disposed end of the extension sleeve is provided for connection to the gate distributor block.

Usually the gate system is secured to a machine plate of the injection molding machine. The embodiment with the extension sleeve means that the gate distributor block and the gate adapter can now be arranged at opposite sides of the machine plate so that the extension sleeve extends through the machine plate so that it is possible to save on structural height on the side which is towards the mold tool and at which the gate distributor block is disposed.

For many situations of use it may also be advantageous if the gate adapter has a heating element. By means of the heating element the gate adapter and therewith all connecting passages provided therein can be brought to a predetermined temperature.

In regard to the gate distributor block a preferred embodiment provides that it does not have any closure elements. In accordance with the invention as far as possible all closure elements are to be arranged in the gate adapter as they can then continue to be used when exchanging a gate distributor block.

A nozzle can be provided in the region of the ingate passage. Basically it is advantageous if at least two distributor passages are arranged in the same component so that, when a heating element is provided, it is possible to ensure that the at least two distributor passages are kept substantially at the same temperature.

It is pointed out however that in principle the gate adapter and the gate distributor block could also be of such a design configuration that they feed melts of different materials, which depending on the respect situation of use can signify that some distributor passages must be kept at different temperatures. If for example two different molten materials are to be supplied to produce a molding consisting of two different materials, the gate adapter must correspondingly have two inlets. According to the invention the gate adapter is then to be adapted to divide up at least one of the two molten materials into two molten material flows.

It will be appreciated that the system according to the invention can also be used for cold runners.

Further advantages, features and possible uses of the present invention will be apparent from the description hereinafter of a preferred embodiment and the accompanying Figures. FIGS. 1 and 2 show a hot runner in the state of the art and have already been described.

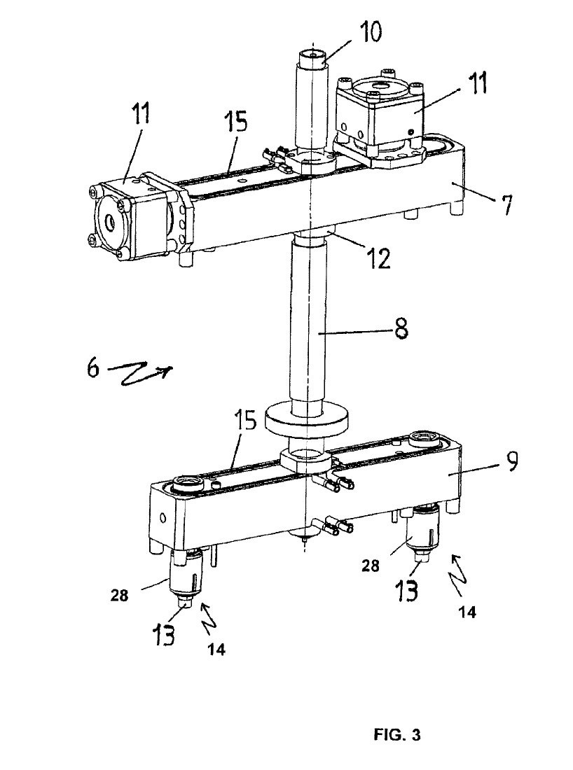

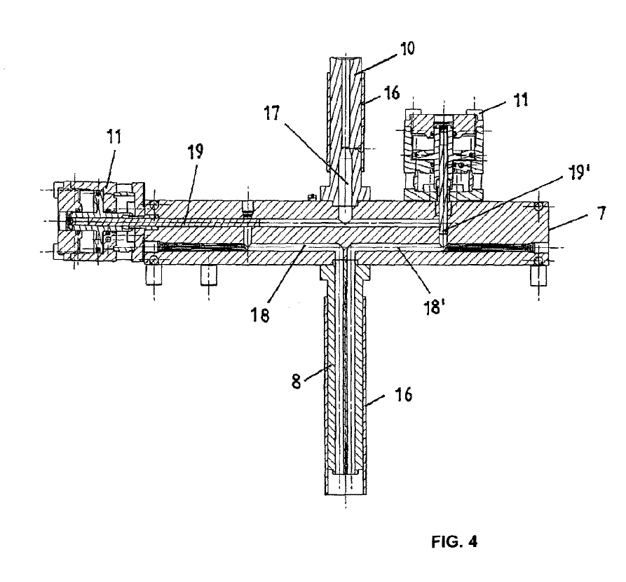

FIG. 3 shows a perspective view of a gate system 6 according to the invention. The gate system 6 comprises a gate adapter 7 with an extension sleeve 8 and a gate distributor block 9. The gate adapter 7 has an inlet 10 for receiving the molten molding material. The received molding material is divided up within the gate adapter into two flows which can be individually selectively opened or closed by means of the needle valves 11. The two molten material flows leave the gate adapter 7 by way of the connecting region 12 and are delivered within the extension sleeve 8 in passages extending in mutually parallel relationship to the gate distributor block 9. The two passages are divided in the gate distributor block 9 to the respective ingate passages 13. A respective nozzle 14 is arranged in the region of the ingate passages 13. It will be seen that both the gate adapter 7 and also the gate distributor block 9 have heating coils 15 for temperature control of the passages. The flow configuration of the molten material can be better seen in the following sectional views in FIGS. 4 through 6.

FIG. 4 shows a sectional view through the gate adapter 7. The gate adapter 7 has an inlet 10 which is also referred to as the gate bush. In the illustrated example the gate bush 10 is surrounded by a heating element 16. The inlet or gate bush 10 has a passage 17 through which the molten molding material flows from the screw (not shown) into the gate adapter 7. The passage 17 is divided into two different connecting passages 18 and 18′. The one connecting passage 18 can be closed by means of the one needle valve 11 shown at the left in FIG. 4 while the other connecting passage 18′ can be closed with the other needle valve 11. In the illustrated embodiment a needle valve is arranged at an edge surface of the gate adapter while the other valve 11 is arranged at the top side of the gate adapter 7. In principle it would also be possible for example for both closure valves 11 to be mounted at the edge surfaces. Adjoining the gate adapter 7 is the extension sleeve 8 which is also surrounded by a heating means 16. The connecting passages 18 and 18′ extend in mutually parallel relationship in the extension sleeve 8.

In the situation shown in FIG. 4 both connecting passages 18 and 18′ are closed by the two closure needles 19 and 19′ of the needle valves 11. Now, for the filling operation, selectively one or both of the needle valves 11 can be opened so that the molten material flows through the feed passage 17 into the two connecting passages 18 and 18′, flows through the gate adapter and issues at the end of the extension sleeve 8.

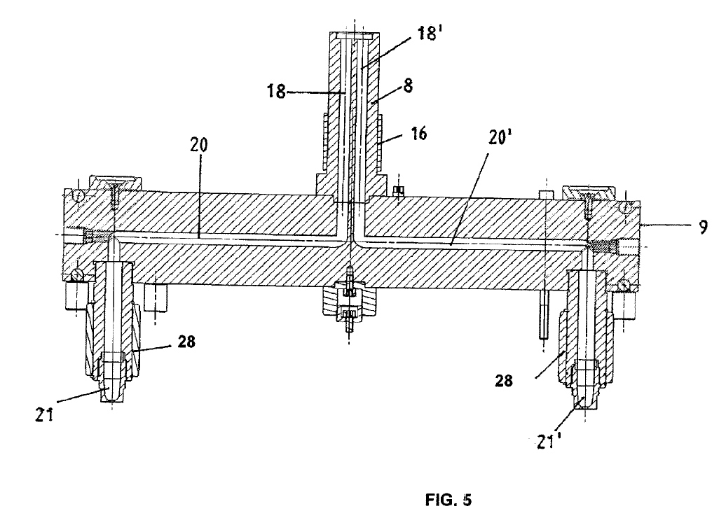

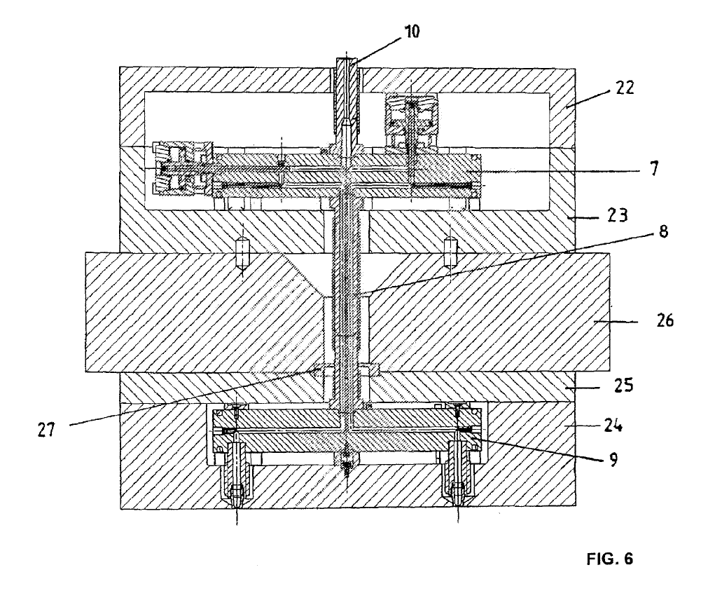

FIG. 5 shows a sectional view of the gate distributor block 9. It is possible to see the end of the extension sleeve 8, being the end which is remote from the gate adapter 7 and which is also surrounded with a heating element 16. The connecting passages 18 and 18′ in the extension sleeve 8 are connected to the two inlets of the gate distributor block 9. The inlets are connected by way of connecting passages 20 and 20′ to the two ingate passages 21 and 21′ in the form of a nozzle. The gate distributor block 9 does not have any closure elements. The nozzle-form ingate passages 21 are also surrounded by a heating element 28. Finally FIG. 6 shows a sectional view through the entire gate system in the installed condition. It is possible to see the gate bush 10, the gate adapter 7, the extension sleeve 8 and the gate distributor block 9. The gate adapter 7 is accommodated in a hot runner plate 23 which is covered by a hot runner cover plate 22. In the same manner the gate distributor block 9 is also accommodated in a hot runner plate 24 covered by a hot runner cover plate 25. A machine plate 26 is arranged between the gate adapter 7 and the gate distributor block 9, wherein the gate adapter 7 and the gate distributor block 9 are connected together by way of a bore in the machine plate 26 by means of the extension sleeve 8. To position the extension sleeve 8 exactly within the bore in the machine plate 26 it has a centering ring 27.

It is additionally possible to provide a rotational securing means which prevents relative rotation between the gate adapter and the extension sleeve and/or between the extension sleeve and the gate distributor block.

To fill the tool cavity without involving the formation of flow seams, it is now possible for example firstly to actuate a needle valve 11 so that a molten material feed passage is opened, beginning from the inlet 10 (or the gate bush), to an ingate passage nozzle 13. Molten material flows through that passage into the tool cavity. As soon as the tool cavity is filled with molten material to such an extent that the ingate passage which is still closed also has molten material flowing therearound, the further needle valve 11 is actuated, whereby the other passage is also opened and molten material is injected through the further ingate passage into the flow of molten material which is already present.

That measure provides that flow seam formation is prevented and at the same time ensures that a substantially constant molten material pressure is formed within the tool cavity.

When replacing the tool, when positioning of the ingate passages also changes, it is only necessary to replace the gate distributor block 9. The gate adapter 7 which contains all the control elements can in contrast continue to be used.

In a further preferred embodiment the electrical power supply for the gate distributor block can also be implemented by way of the gate adapter or the extension sleeve 8. In that case a series of electrical control connections would also have to be provided in the gate adapter 7, to which connections the gate distributor block 9 can have access. Basically then the gate distributor block is only fitted onto the gate adapter 7 or the extension sleeve 8 arranged therebetween, without additional electrical connections being required. The gate system is practically immediately ready for use.

### LIST OF REFERENCES

1 hot runner
2 inlet/gate bush
3 distributor passage
4 connecting passages
5 needle valves
6 gate system
7 gate adapter
8 extension sleeve
9 gate distributor block
10 inlet/gate bush
11 needle valve
12 connecting region
13 ingate passages/nozzle tip
14 nozzle
15 heating coils
16 heating element
17 passage
18 connecting passages
19 closure needles
20 connecting passages
21 ingate passages
22 hot runner cover plate
23 hot runner plate
24 hot runner plate
25 hot runner cover plate
26 machine plate
27 centering ring
28 nozzle heating means

What is claimed is:

1-19. (canceled)

20. A gate adaptor for receiving a molten molding material and for the discharge thereof to a gate distributor block (9), wherein the gate adaptor (7) has an inlet (10) for receiving the molten molding material, first and second outlets for the controlled discharge of the molten molding material and first and second closable connecting passages (18, 18′) which respectively connect an outlet to the inlet (10).

21. A gate adaptor as set forth in claim 20 wherein the two connecting passages (18, 18′) are so arranged that each is individually closable without adversely affecting the flow through the other connecting passage.

22. A gate adaptor as set forth in claim 20 wherein closure valves are provided for closing the connecting passages (18, 18′).

23. A gate adaptor as set forth in claim 20 wherein at least three outlets and at least three connecting passages (18, 18′) are provided connecting the outlets to the inlet (10).

24. A gate adaptor as set forth claim 20 wherein the gate adaptor is substantially plate-shaped with a first side surface, a second side surface and a peripherally extending edge surface.

25. A gate adaptor as set forth in claim 24 wherein the inlet (10) is arranged at the first side surface and the outlets at the second side surface.

26. A gate adaptor as set forth in claim 24 wherein at least two outlets are arranged in a continuous connecting region (12), the area of which is less than 200 cm², preferably less than 150 cm² and particularly preferably less than 100 cm².

27. A gate adaptor as set forth in claim 20 wherein an extension sleeve (8) is provided having first and second ends and having at least two substantially parallel passages which extend through the extension sleeve (8), wherein the extension sleeve (8) is so connected to the outlets of the adaptor that controlled discharge of the molten molding material by way of the passages of the extension sleeve (8) is possible.

28. A gate adaptor as set forth in claim 20 wherein the gate adaptor (7) has a heating element (16).

29. A gate distributor block for connection to a gate adaptor as set forth in claim 20 wherein at least the gate distributor block (9) has two inlets for connection to outlets of the gate adaptor (7) and at least two ingate passages (13) for connection to a mold cavity, wherein each ingate passage (13) is connected by way of distributor passages to at least one inlet of the gate distributor block (9).

30. A gate distributor block as set forth in claim 29 wherein the distributor passages have no closure elements.

31. A gate distributor block as set forth in claim 29 wherein at least one ingate passage (13) has a nozzle (14).

32. A gate distributor block as set forth in claim 29 wherein at least two distributor passages are arranged in a same component.

33. A gate distributor block as set forth in claim 29 wherein least one heating element (15) is provided.

34. A gate distributor block as set forth in claim 33 wherein the at least one heating element (16) is so arranged that at least two distributor passages are kept substantially at the same temperature.

35. A gate distributor block as set forth in claim 29 wherein at least two inlets are arranged in a continuous connecting region (12), the area of which is less than 200 cm².

36. A gate system comprising a gate adapter and a gate distributor block wherein the gate adapter is for receiving a molten molding material and for the discharge thereof to the gate distributor block (9), wherein the gate adaptor (7) has an inlet (10) for receiving the molten molding material, first and second outlets for the controlled discharge of the molten molding material and first and second closable connecting passages (18, 18′) which respectively connect an outlet to an inlet (10) of the distributor block, said distributor block (9) having at least two inlets for connection to outlets of the gate adaptor (7) and at least two ingate passages (13) for connection to a mold cavity, wherein each ingate passage (13) is connected by way of distributor passages to at least one inlet of the gate distributor block (9).

37. A gate system as set forth in claim 36 wherein there a plurality of gate adaptors are provided.

38. A gate system as set forth in claim 36 wherein the gate distributor block is connected to the gate adaptor by way of an extension sleeve, wherein the gate distributor block and the gate adaptor are arranged on opposite sides of a machine plate so that the extension sleeve passes through the machine plate.
